(19) United States
(12) Patent Application Publication
(10) Pub. No.: US 2024/0323216 A1
(43) Pub. Date: Sep. 26, 2024

(54) CREDENTIAL-BASED SECURITY POSTURE ENGINE IN A SECURITY MANAGEMENT SYSTEM

(71) Applicant: Microsoft Technology Licensing, LLC, Redmond, WA (US)

(72) Inventors: Tatyana Gershanov, Givatayim (IL); Ram Haim Pliskin, Rishon Lezion (IL); Tamer Salman, Haifa (IL)

(21) Appl. No.: 18/186,768

(22) Filed: Mar. 20, 2023

(51) Int. Cl. H04L 9/40

(52) U.S. Cl. CPC H04L 63/1433; H04L 63/0876; H04L 63/1425

(57) ABSTRACT

Methods, systems, and computer storage media for providing security posture management using a credential-based security posture engine in a security management system. Security posture management provides security operations-including identifying and remediating risk exposure—to securely manage resources and workloads in computing environments. Security posture management is provided using the credential-based security posture engine that is operationally integrated into the security management system. In operation, credential scan results associated with a computing device are accessed. The computing device is scanned using a credential-based security posture engine that supports generating a security posture of computing environments. Based on the scan results, an unsecured credential associated with accessing a resource in the computing environment is identified. A security posture visualization associated with the computing environment is generated. The security posture visualization comprises the unsecured credential and the resource. The security posture visualization is communicated to cause display of the security posture visualization.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, cloud security posture management (CSPM) and enterprise security posture management can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing security posture management using a credential-based security posture engine of a security management system. Security posture management supports management of security aspects of resources and workloads in computing environments including identifying and remediating risk. Security posture management is provided using the credential-based security posture engine that is operationally integrated into the security management system. The security management system supports a credential-based security framework of computing components associated with processing credentials for determining a security posture of a computing environment. The credential-based security posture engine operates to provide security posture management based on scanning a computing environment for unsecured credentials and evaluating a security risk associated with the unsecured credentials. For example, a security administrator can request a security posture of their computing environment, and the security posture is provided based on credential-based security posture management operations that prioritize and filter security posture information based on unsecured credentials identified and validated in the computing environment.

Conventionally, security management systems are not configured with a comprehensive computing logic and infrastructure to efficiently provide adequate credential-based security posture information. For example, alerts and remediation workflows for a computing environment can be continuously generated and provided as security posture information-without prioritization and filtering-because the security management system lacks integration with credential-based security posture management operations. Merely identifying and providing security posture information-without additional prioritization and filtering of the security posture information-causes deficient functioning of the security management system. For example, a deficient security posture interface does not adequately present the security posture information in a manner that efficiently encapsulates the security posture of a computing environment. Moreover, without adequate prioritization of security posture information, potential threats can become actual threats which can lead to unauthorized access to data in the computing environment and malicious operations in the computing environment.

A technical solution—to the limitations of conventional security management systems—can include the challenge of providing credential scanning and credential validation, prioritization and filtering of security posture information—and providing security management operations and interfaces via a credential-based security posture engine that supports a credential-based security posture management in a security management system. As such, the security management system can be improved based on credential-based security posture management operations in the security management system that operate to effectively summarize and provide security posture information of a computing environment in a particular manner.

In operation, credential scan results-associated with a computing device in a computing environment—are accessed. The computing device is scanned using a credential-based security posture engine that supports generating security postures of computing environments. Based on the credential scan results, an unsecured credential associated with accessing a resource in the computing environment is identified. A risk score that quantifies a security exposure associated with the unsecured credential and the resource is generated. Based on the risk score, a security posture visualization associated with the computing environment is generated. The security posture visualization comprises the unsecured credential and the resource. The security posture visualization is communicated to cause display of the security posture visualization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system for providing sensitive data scanning in a credential-based security posture engine, in accordance with aspects of the technology described herein;

FIG. 1C-1E are security management system interfaces of an exemplary security management system for providing sensitive data scanning in a credential-based security posture engine, in accordance with aspects of the technology described herein;

FIG. 2A is a block diagram of an exemplary security management system for providing security posture management using a credential-based security posture engine, in accordance with aspects of the technology described herein;

FIG. 2B is a block diagram of an exemplary security management system for providing security posture management using a credential-based security posture engine, in accordance with aspects of the technology described herein;

FIG. 3 provides a first exemplary method of providing security posture management using a credential-based security posture engine, in accordance with aspects of the technology described herein;

FIG. 4 provides a second exemplary method of providing security posture management using a credential-based security posture engine, in accordance with aspects of the technology described herein;

FIG. 5 provides a third exemplary method of providing security posture management using a credential-based security posture engine, in accordance with aspects of the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

A security management system supports management of security aspects of resources and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response.

Conventionally, security management systems are not configured with a comprehensive computing logic and infrastructure to efficiently provide adequate credential-based security posture information. For example, alerts and remediation actions for a computing environment can be continuously generated and provided as security posture information-without suitable prioritization and filtering-because the security management system lacks integration with credential-based security posture management operations. In addition, without adequate prioritization of security posture information, potential threats can become actual threats which can lead to unauthorized access to data in the computing environment and malicious operations in the computing environment.

Moreover, merely identifying and providing security posture information causes deficient functioning of the security management system. A deficient security posture interface does not adequately present the security posture information in a manner that efficiently encapsulates the security posture of a computing environment. As such, a more comprehensive security management system—with an alternative basis for performing secure management operations—can improve computing operations and interfaces in security management systems.

Embodiments of the present technical solution are directed to systems, methods, and computer storage media for, among other things, providing security posture management using a credential-based security posture engine of a security management system. Security posture management supports management of security aspects of resources and workloads in computing environments including identifying and remediating risk. Security posture management is provided using the credential-based security posture engine that is operationally integrated into the security management system. The security management system supports a credential-based security framework of computing components associated with processing credentials for determining a security posture of a computing environment.

The credential-based security posture engine operates to provide security posture management based on scanning a computing environment for unsecured credentials and evaluating a security risk associated with the unsecured credentials. For example, a security administrator can request a security posture of their computing environment, and the security posture is provided based on credential-based security posture management operations that prioritize and filter security posture information based on unsecured credentials identified and validated in the computing environment.

At a high level, the security management system supports credential-based security posture management operations that provide security posture information for a computing environment based on unsecured credentials in the computing environment. By way of context, computing devices in a computing environment may have unsecured credentials stored on the computing devices. Unsecured credentials can refer to security credentials that can be searched and found because the credentials are insecurely stored. In particular, unsecured credentials may be available for several different reasons-including because users store their credentials in plaintext or users create scripts to access resources—where the scripts include their credentials in plaintext. Additionally, unsecured credentials may be available because security vulnerabilities (e.g., log files, text files, etc.) in software provide access to credentials. Specifically, these credentials can be stored or misplaced in many locations on a system, including plaintext files (e.g. bash history), operating system or application-specific repositories (e.g. credentials in registry), or other specialized files/artifacts (e.g. private keys).

An attacker can access unsecured credentials to connect to resources in the computing environment. For example, if a user stores their SSH credentials (e.g., username, password, server address, port number) in plaintext on their computing device, a credential scanner can be used to scan the computing device to identify the unsecured credentials. Moreover, unsecured credentials can expand the scope of a malicious actor's attack, if the unsecured credentials provide access to additional resources or highly sensitive data. Different types of unsecured credentials can expose a computing environment to different types of attacks and severity level of attacks.

A risk score can be computed to quantify the security exposure associated with an unsecured credential, such that, security posture information is prioritized and presented based on the risk score. By way of example, an analysis can be done on historical unsecured credentials and their corresponding impact quantified. Based on the analysis, new unsecured credentials can be evaluated and assigned risk scores associated with their likely impact on the security of a computing environment. The risk score can be calculated based on a likelihood or impact of a security threat (e.g., an actual threat or a potential threat) associated with an identified unsecured credential and corresponding additional factors.

In this way, a risk score is a calculated number (score) that reflects the severity of a risk due to some factors. Risk scores are calculated by multiplying probability (e.g., probability score) and impact (e.g., impact score)—though other factors, such as weighting may be also be part of calculation. For qualitative risk assessment, risk scores are normally calculated using factors based on ranges in probability and impact. In quantitative risk assessments, risk probability and impact inputs can be discrete values or statistical distributions. For example, if an unsecure credential provides access to a database without highly sensitive data, the risk score may be low; however, if an unsecure credential provides access to several databases with highly sensitive data, then the risk score may be high. The risk score can be part of an overall risk assessment that is based on credential-based posture data including a type of unsecured credential, a resource type, a type of computing device, and attack path analysis. Other variations and combinations of risk scoring systems and credential-based security posture data are contemplated for embodiments described herein.

Security posture information can be generated and presented in a security posture visualization (i.e., a user interface graphic or visual aid that conveniently synthesizes the security information to help a user quickly understand and interpret the security posture information) where the security posture information is generated based in part on a risk assessment or a risk score. The security posture information can further include remediation information (e.g., remediation action or workflows) for addressing any potential risk associated with the unsecured credentials.

The security posture information in the security posture visualization can identify the unsecured credential, a computing device associated with the unsecured credential, and a resource associated with the unsecured credential, amongst other types of security posture information. The security posture information can be generated based on the risk score such that security posture information is prioritized and filtered based on the risk score. A prioritization identifier (e.g., high, medium, low) can be provided in the security posture visualization in combination with an alert associated with the unsecured credential. Alternatively, a notification associated with the unsecured credential or the alert can be communicated. Other variations and combinations of communications associated with the unsecured credential are contemplated with embodiments described herein.

It is further contemplated that the security posture information and prioritization can be performed for alerts associated with unsecured credentials and alerts that are not associated with unsecured credentials. As such, a user is provided with the highest risk unsecured credentials and resources, where the highest risk unsecured credentials are prioritized over less risky unsecured credentials and resources, or other less risky alternative type of alerts associated with the computing environment. As such, a credential-based security posture engine in a security management system can support identifying and evaluating unsecured credentials to support determining and presenting a security posture of a computing environment.

Advantageously, the embodiments of the present technical solution include several inventive features (e.g., operations, systems, engines, and components) associated with a security management system having the credential-based security posture engine. Inventive features will be described with reference to operations for providing security posture information using a credential-based security posture engine in a security management system. Functionality of the embodiments of the present technical solution will further be described, by way of an implementation and anecdotal examples, to demonstrate that the credential-based security management operations—(e.g., credential scanning and validating unsecured credentials, and generating a security posture visualization based on a risk assessment associated with unsecured credentials)—are a solution to a specific problem in a software development environment to improve computing operations and interface for security management systems. For example, the operations provide an improved user interface that summarizes and presents security posture information-associated with unsecured credentials—in a particular manner to facilitate security posture management. Overall, these improvements result in less CPU computation, smaller memory requirements, and increased flexibility in security management systems.

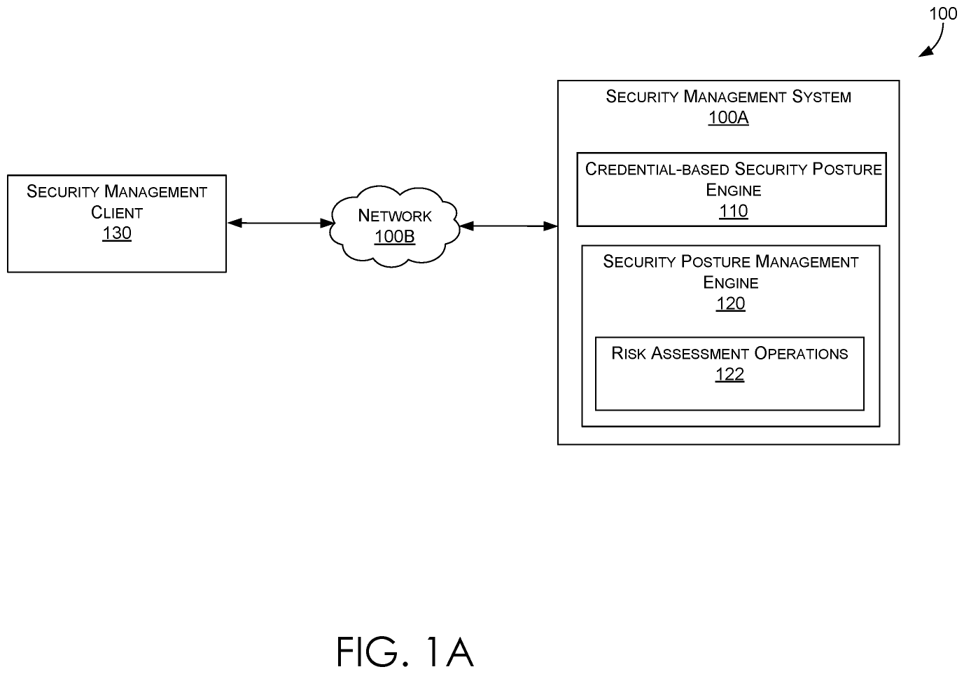

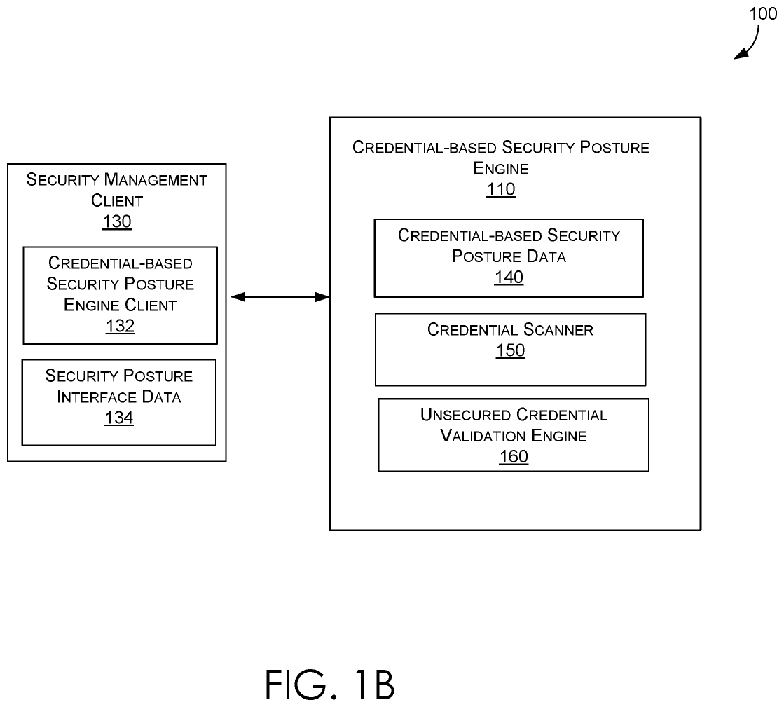

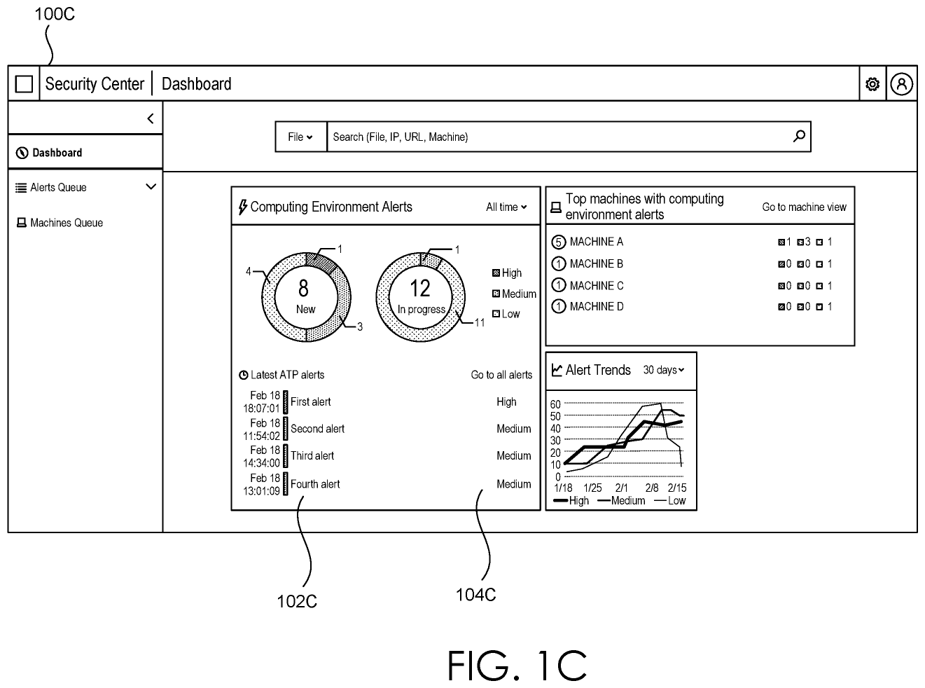

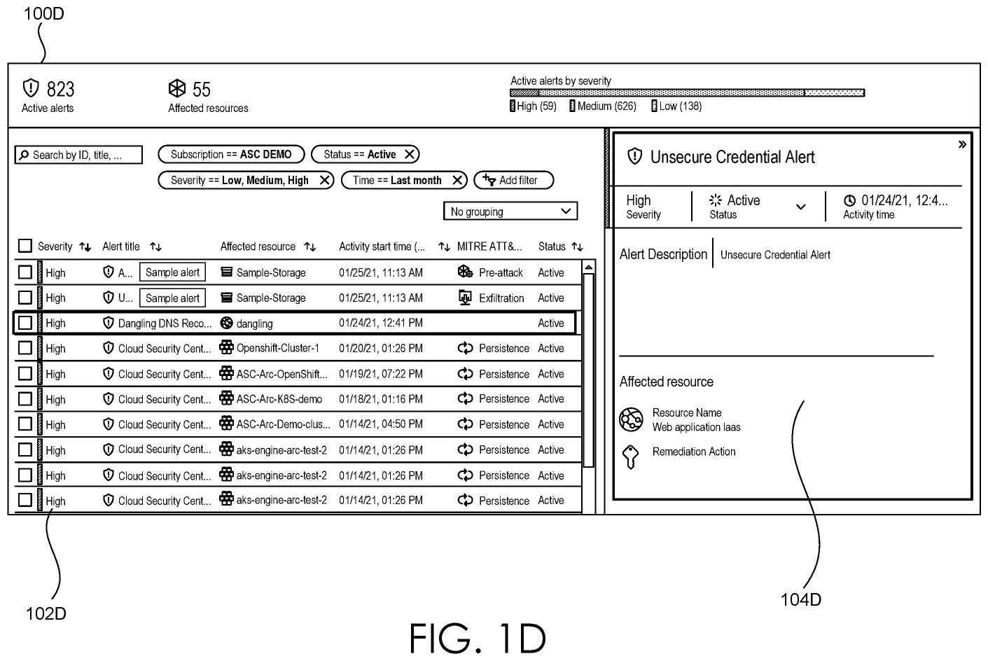

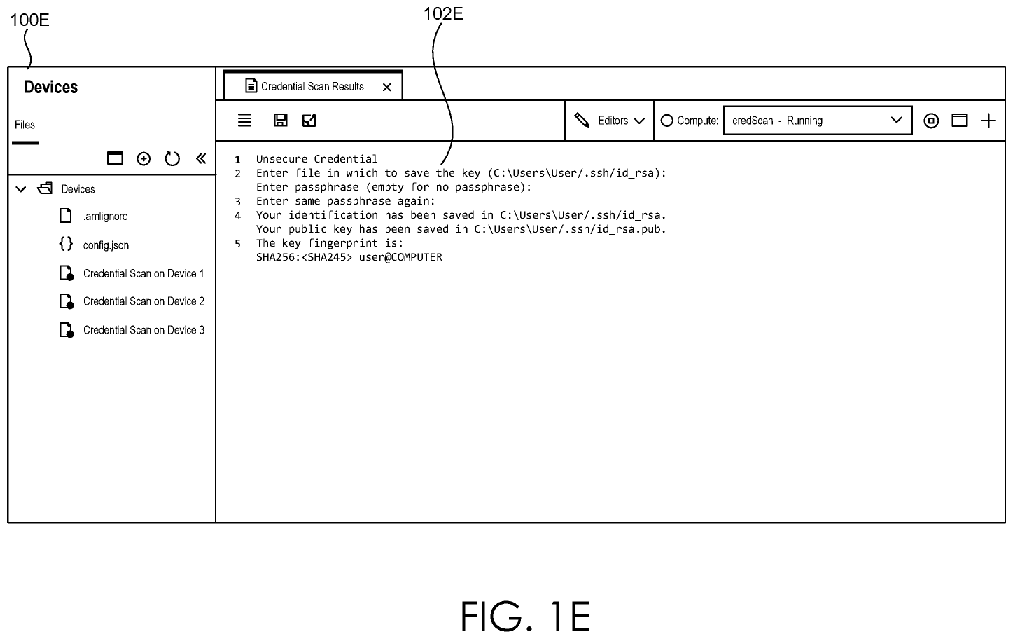

Aspects of the technical solution can be described by way of examples and with reference to FIGS. 1A-1E. FIG. 1A illustrates a cloud computing environment (system) 100 and security management system 100A. The security management system 100A includes network 110B, credential-based security posture engine 110, security posture management engine 120 with risk assessment operations 122, and security management client 130.

The cloud computing environment 100 provides computing system resources for different types of managed computing environments. For example, the cloud computing platform that supports delivery of computing services-including servers, storage, databases, networking, and intelligence. A plurality of security management clients (e.g., security management client 130) include hardware or software that access resources in the cloud computing environment 100. Security management client 130 can include an application that supports client-side functionality associated with cloud computing environment. The plurality of security management clients can access computing components of the cloud computing environment 100 via a network (e.g., network 100B) to perform computing operations.

The security management system 100A is designed to provide security posture management using the credential-based security posture engine 110. The security management system 100A provides an integrated operating environment based on a security management framework of computing components associated with processing credentials for determining a security posture of a computing environment. The security management system 100A integrates credential-based security posture management operations—that prioritize and filter security posture information based on unsecured credentials identified and validated in the computing environment-into security management operations and interfaces to effectively provide security posture information and remediation information. For example, a security administrator can request a security posture of their computing environment, and the security posture is provided based on credential-based security posture management operations via the security management client 130. The security management system supports generating security posture visualization with credential-based security posture information associated with the computing environment.

The credential-based security posture engine 110 is responsible for providing security posture management based on credential-based security management operations. The credential-based security posture engine 110 operates with security management system components (e.g., security posture management engine 120) to provide security posture management. The security posture management engine 120 operates to provide visibility to security status of resources in a computing environment. The security posture can be associated with network, data, and identity resources of a computing environment.

The security posture management engine 120 may assess threats and develop risk scores-using risk assessment operations 122 including attack path analysis-associated with threats and attack paths. An attack path analysis can refer to a graph-based algorithm that scans a cloud security graph to identify exploitable paths that attackers may use to breach a computing environment. The attack path analysis exposes attack paths and suggests remediation actions for issues that would break the attack path and prevent a successful breach. For example, if an unsecured credential is identified on a computing device, and the unsecured credential provides access to a single resource, the corresponding attack path analysis would identify the potential impact based on the computing device with the unsecured credential and the single resource. However, if the unsecured credential provides access to multiple resources, the corresponding attack path analysis would identify the potential impact based on the computing device with the unsecured credential and the multiple resources. In this way, the attack path analysis help address security issues that pose immediate threat with the greatest potential of being exploited in a computing environment. Other variations and combinations of risk assessment operations are contemplated with embodiments of the present disclosure.

The security posture management engine 120 can further support generating security posture visualizations based on the security posture information and risk assessment. For example, a security posture visualization can prioritize of different alerts based at least on part on secure posture information (e.g., unsecured credentials and corresponding resources, unsecured credential device, and risks scores) associate with the credential-based security posture. The security posture visualization can further include remediation actions associated different alerts—including alerts that are associated with an unsecured credential. Advantageously, a remediation action associated with a properly prioritized alert-provided in combination with an unsecured credential—can be selected and communicated to cause the remediation action to be performed. The remediation action can address an actual threat or potential threat associated with the alert and unsecured credential. For example, a remediation action can include off-boarding a computing device, disabling a user, quarantining a file; turning off external email, or running an antivirus scan. Other variations and combinations of security posture visualizations with remediation actions are contemplated with embodiments described herein.

With reference to FIG. 1B, FIG. 1B illustrates credential-based security posture engine 110—having credential-based security posture data 140, credential scanner 150, and unsecured credential validation engine 150; and security management client 130 having credential-based security posture engine client 132 and security posture interface data 134.

The credential-based security posture engine 110 is responsible for communicating with a security management client 130 having the credential-based security posture engine client 132. The credential-based security posture engine client 132 supports client-side security posture management operations for providing security management in the security management system. The credential-based security posture engine client 132 can support credential scanning, credential validation, accessing and presenting a security posture visualization, and communicating an indication to perform a remediation action for an alert associated with an unsecured credential. In this way, credential-based security posture data 140 and security posture information can be communicated between the credential-based security posture engine 110, the security posture management engine 120, and the security management client 130. The security posture management client 130 causes display the security posture information as security posture interface data 134. For example, the security posture interface data 134 can include security posture visualizations generated at the security posture management engine 120, as discussed herein.

The credential-based security posture engine 110 is responsible for performing credential-based security posture management operations and generating credential-based security posture data 140. In particular, credential-based security posture data can refer to credential scanning information and credential artifacts that are retrieved to support analyzing credentials and determining whether the credentials are unsecured credentials and provide access to resources in the computing environment. Additional credential artifacts can refer to contextual data or metadata associated with an unsecured credential. For example, a file name, file location, script code, or additional text and information retrieved in association with a scan for an unsecured credential can be stored as credential artifacts in credential-based security posture data.

The credential-based security posture management operations include credential scanning to generate credential scan results. Credential scan results can be generated for a computing device. The credential scan results are generated based on credential scanning using a credential scanner 150 associated with the credential-based security posture engine 110. The credential scanner 150 can be used to scan a storage component of a computing device or a disk image of the computing device. The credential scan results support identifying an unsecured credential and a corresponding resource associated with the unsecured credential. For example, the unsecured credential and additional credential artifacts may explicitly identify a resource associated with the unsecured credentials.

In another example, an inference determination is made to identify the resource associated with the unsecured credential; the inference can be made using additional credential artifacts. In addition, the unsecured credential may be evaluated using a directory service or other types of credential management databases or services associated with the computing environment to determine the resource associated with the unsecured credential.

The unsecured credential validation engine 160 supports validating access to a resource based on an unsecured credential. The unsecured credential is validated to determine whether the unsecured credential provides access to the resource. For example, a username and password unsecured credential can be identified and validated as providing access to a network associated with an active directory service. The unsecured credential is validated for the resource because of the additional security risk or exposure that is implicated if the unsecured credential can be used to access the resource. Validating the unsecured credential in this way, provides an additional factor that is considered when computing a risk score associated with the unsecured credential. Moreover, a result of the validating the unsecured credential can further be provided via a security posture visualization for the computing environment. Validating the unsecured credential can be based on credential management tools in the computing environment that determine whether the unsecured credentials provide access to their corresponding resources.

With reference to FIG. 1C, FIG. 1C illustrates a security management system interface 100C that illustrates a security management system interface 100C associated with a security posture visualization. The security management system interface 100C can be associated with the security management client 130, the credential-base security posture engine 110, and the security posture management engine 120. Credential-based security posture data 140 can be communicated to a security posture management 120 where risk assessment operations are performed to quantify a risk (e.g., compute risk score) of an unsecure credential. Based on risk assessment operations 122 and credential-based security posture data 140 a security posture visualization is generated for the computing environment. The security posture visualization is communicated to the security management client 130 and caused to be displayed in security management interface 110C.

An alerts interface portion 102C can include a plurality of alerts associated with the security management system. The alerts may be include a first set of alerts associated with unsecured credentials and a second set of alerts not associated with unsecured credential, where the alerts are all prioritized relative to each other. It is contemplated that alerts associated with unsecured credentials and alerts not associated with unsecured credentials can be filtered separately via the interface. The prioritization identifier interface portion 104C provides corresponding prioritization identifiers (e.g., high, medium, low) that corresponding to each alert. Other types of security posture information and credential-based security posture data can be provided as part of the security management system interface 100C.

With reference to FIG. 1D, FIG. 1D illustrates a security management system interface 100D that illustrates a security management system interface 100D. In particular, the security management system interface 100D includes a sorted listing of alerts based on the prioritization identifier (i.e., severity) in alerts interface portion 102D. The alerts can be associated with credential-based security posture data including an unsecured credential type, a resource type, and an unsecured credential validation status (not shown). The security management system interface 100D can further include a security posture information details portion 104D that provides additional details corresponding to a selected alert. It is contemplated that the selected alert can be associated with a remediation action that is selectable to trigger performing the remediation action to address the actual threat or potential threat associated with the alert.

With reference to FIG. 1E, FIG. 1E illustrates a security management system interface 100E that illustrates unsecured credential scan results 102E and corresponding additional credential artifacts associated with the unsecured credential. The security management system interface 100E can support selecting a computing device for performing a credential scan to identify unsecured credentials. The credential scan is performed on the computing device and credential scan results are communicated to support generating credential-based security posture data and prioritizing and filtering security posture information.

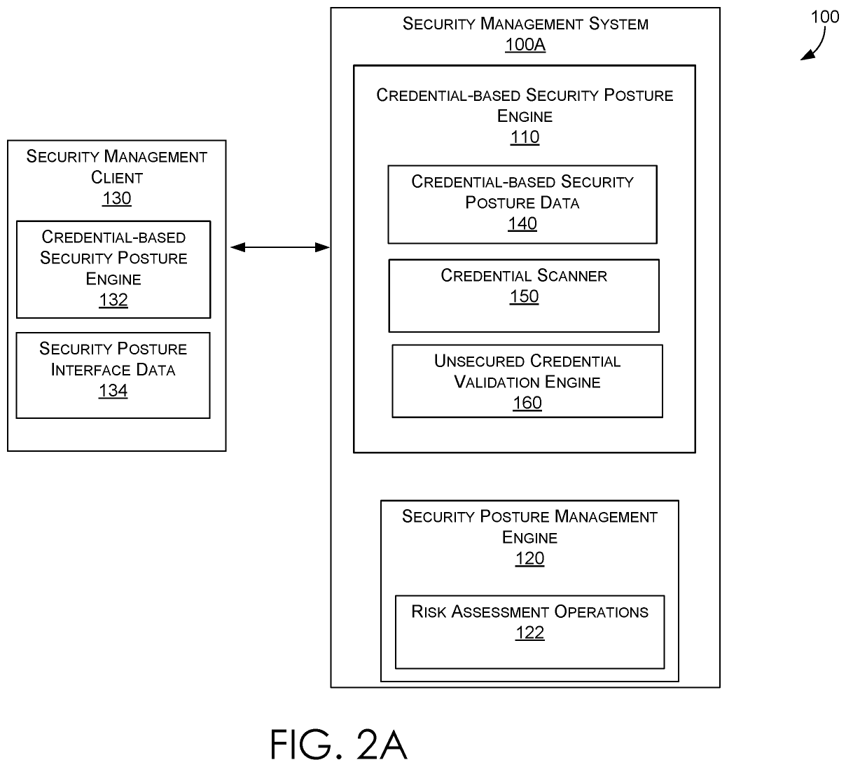

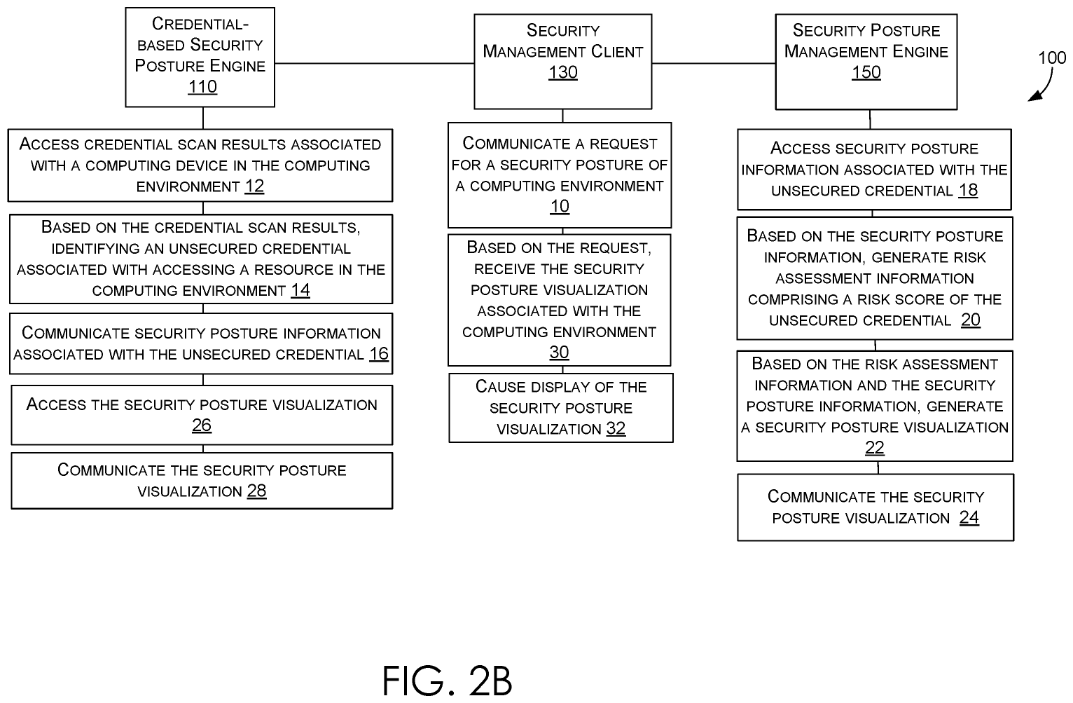

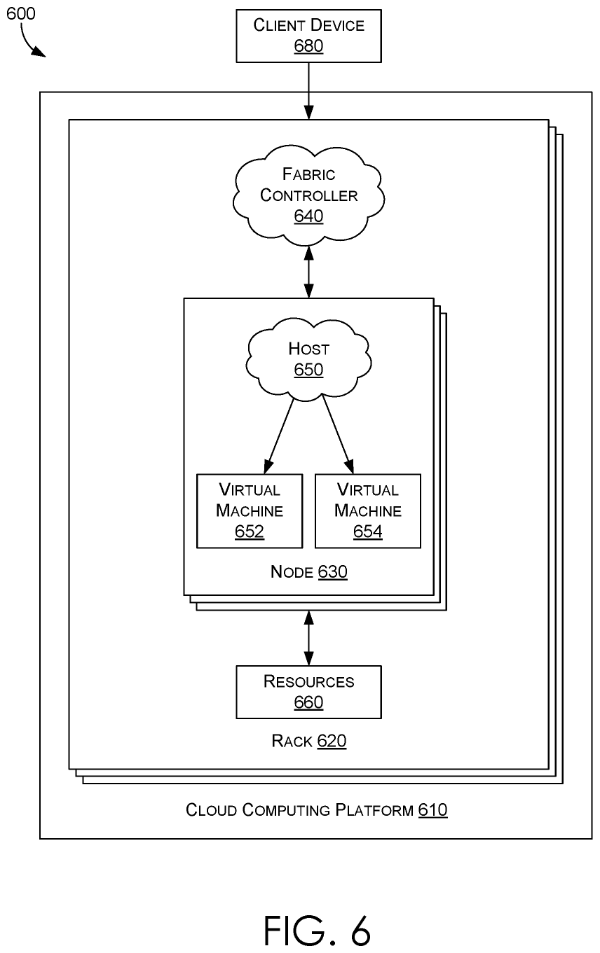

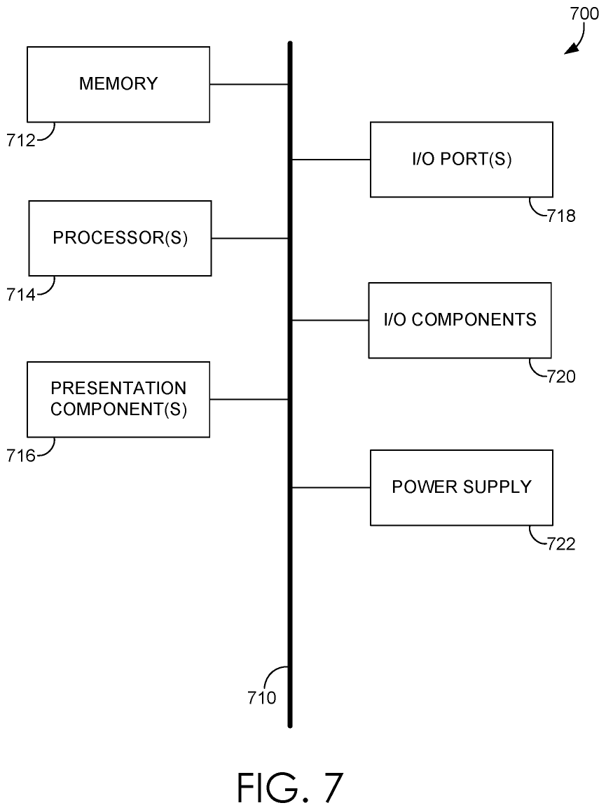

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example cloud computing system 100 in which methods of the present disclosure may be employed. In particular, FIG. 2A shows a high level architecture of the cloud computing system 100 in accordance with implementations of the present disclosure. Among other engines, managers, generators, selectors, or components not shown (collectively referred to herein as “components”), the technical solution cloud computing system 100 corresponds to FIGS. 1A and 1B.

With reference to FIG. 2A, FIG. 2A illustrates a security management system 100A having credential-based security posture engine 110, credential scanner 150, and unsecured credential validation engine 160. The security management system 100A further includes security posture management engine 120 including risk assessment operations 122. The security management client 130 further includes credential-based security posture engine 132 and security posture interface data 134.

The credential scanner 150 of the credential-based security posture engine 110 supports scanning for unsecured credentials associated with a computing device. The credential scanner is associated with the credential-based posture engine 110 to support identifying, for a plurality of computing devices in a computing environment, a plurality of unsecured credentials and their corresponding resources. For example, the credential scanner 150 can scan a storage device or a disk image associated with computing device. The credential scanner 150 can operate with the credential-based security posture engine client 132 on a computing device to support performing credential scanning operations. The credential scanner 150 generates and communicates the credential scan results that are provided to support credential-based security posture management operations. The credential scan results can include an unsecured credential and a resource that is accessible using the unsecured credential, and may further include additional credential artifacts and metadata associated with the executing the credential scan.

The credential-based security posture engine 110 supports validating unsecured credentials to determine whether the credential provides access to the resource. A first unsecured credential may provide access to a resource while a second unsecured credential does not provide access to a resource. Both the first and second unsecured credentials can be provided in a security posture visualization with further interface elements indicating information associated with validating the unsecured credential. For example, the security posture visualization can indicate that an unsecured credential has been validated or not validated and further identify a corresponding resource associated with a validated unsecured credential.

The credential-based security posture engine 110 can aggregate credential-based security posture data 140 that is processed to support generating a security posture visualization. The credential-based security posture data 140 can be associated with executing an attack path analysis or executing risk assessment operations to generate risks scores. The credential-based security posture data 140 can specifically identify the unsecured credential and correspond credential artifacts, a resource associated with the unsecured credential, and the computing device associated with the unsecured credential.

The security posture management engine 120 is responsible for executing an attack path analysis based on credential-based security posture data 140. The attack path analysis exposes attack paths and suggests remediation actions for issues that would break the attack path and prevent a successful breach. For example, if an unsecured credential is identified on a computing device, and the unsecured credential provides access to a single resource, the corresponding attack path analysis would identify the potential impact based on the computing device with the unsecured credential and the single resource.

The security posture management engine 120 is responsible executing a risk assessment based on credential-based security posture data. The risk assessment includes generating risk scores for each of a plurality of unsecured credentials to quantify their security exposure of the computing environment. The risk score (e.g., high, medium, low) can be based on each unsecured credential and corresponding risk assessment factors of the unsecured credential. The risk assessment factors can include an unsecured credential type, a resource type, an unsecured credential validation status, and an attack path analysis.

The security posture management engine 120 is responsible for generating a security posture visualization comprising a plurality of alert. An alert from the plurality of alerts is associated with an unsecured credential and a prioritization identifier. As used herein, prioritization identifiers may correspond to a computed risk score for an unsecured credential. The plurality of alerts are provided in the security posture visualization based on their corresponding prioritization identifiers. The security posture visualization can further include a remediation action associated with an alert. The remediation action is executable to address a security threat associated with the alert.

The security management client 130 can support accessing a security posture visualization and causing display of the security posture visualization. The security management client 130 can include the credential-based security posture engine 132 that supports performing credential-based security posture management operations on a client side based on the credential-based security posture engine 110 and security posture management engine 120. The security management client 130 supports communicating a request for a security posture the computing environment. Based on the request, the security management client 130 receives a security posture visualization associated with the computing environment. The security posture visualization can include an alert associated with an unsecured credential that provides access to a resource in the computing environment. The security posture management client 130 causes display the security posture visualization as security posture interface data 134. For example, the security posture interface data 134 can include security posture visualizations generated at the security posture management engine 120, as discussed herein.

The security management client 130 can further support executing a remediation action. In particular, the security posture visualization can include a remediation action for an alert associated with an unsecured credential. The security management client 130 can receive an indication to perform the remediation action associated with the unsecured credential. Based on receiving the indication to execute the remediation action, the security management client communicate the indication to execute the remediation action to cause execution of the remediation action.

With reference to FIG. 2B, FIG. 2B illustrates a software development environment having credential-based security posture engine 110, security management client 130, and security posture management engine 150. At block 10, the security management client 130 communicates a request for a security posture of a computing environment. At block 12, the credential-based security posture engine accesses credential scan results associated with a computing device in the computing environment; and at block 14, based on the credential scan results, identifies an unsecured credential associated with accessing a resource in the computing environment. At block 16, the credential-based security posture engine 110 communicates security posture information associated with the unsecured credential.

At block 18, the security posture management engine 150 accesses security posture information associated with the unsecured credential; and block 20, based on the security posture information, generates risk assessment information comprising risk score of the unsecured credential. At block 22, the security posture management engine, based on the risk assessment information and the security posture information, generates a security posture visualization; and at block 24, communicates the security posture visualization. At block 26, the credential-based security posture engine 110 accesses the security posture visualization; and at block 28, communicates the security posture visualization. At block 30, the security management client 130, based on the request for the security posture of the computing environment, receives a security posture visualization associated with the computing environment. And, at block 32, the security management client causes display of the security posture visualization.

### Example Methods

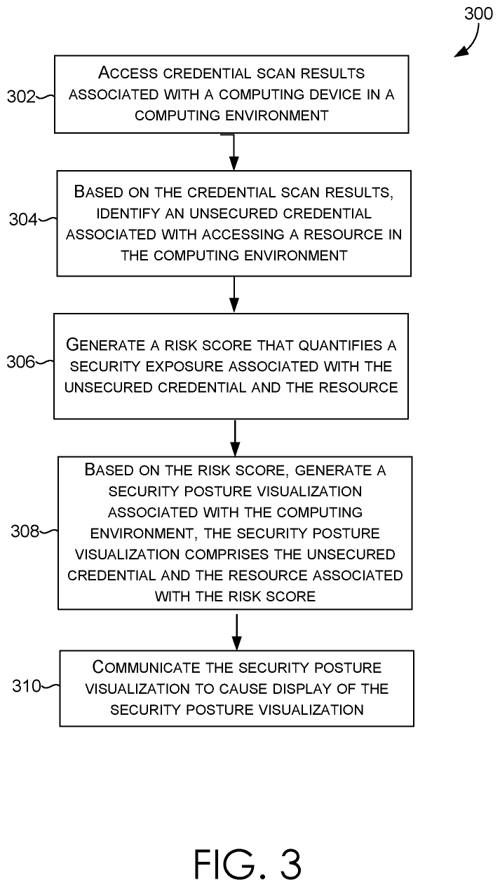

With reference to FIGS. 3, 4, and 5, flow diagrams are provided illustrating methods for providing security posture management using a credential-based security posture engine in a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system or computing system).

Turning to FIG. 3, a flow diagram is provided that illustrates a method 300 for providing security posture management using a credential-based security posture engine in a security management system. At block 302, credential scan results associated with a computing device in a computing environment are accessed. At block 304, based on the credential scan results, an unsecured credential associated with accessing a resource in the computing environment is identified. At block 306, a risk score that quantifies a security exposure associated with the unsecured credential is generated. At block 308, a security posture visualization associated with the computing environment is generated, the security posture visualization comprises the unsecured credential and the resource.

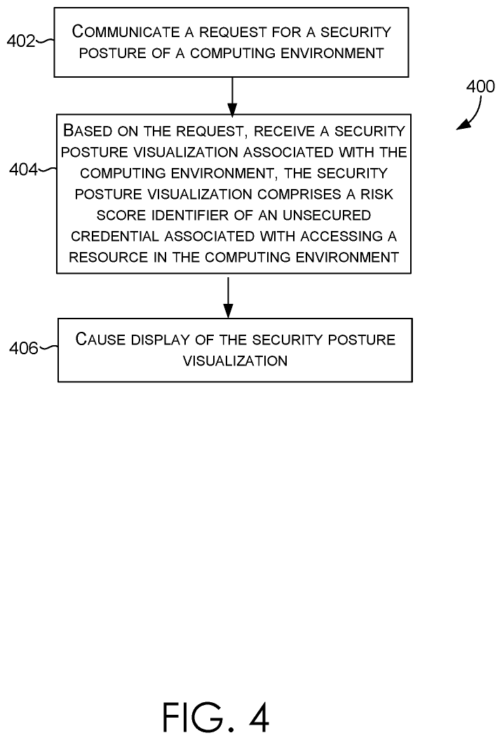

Turning to FIG. 4, a flow diagram is provided that illustrates a method 400 for providing security posture management using a credential-based security posture engine in a security management system. At block 402, a request for a security posture of a computing environment is communicated. At block 404, based on the request, a security posture visualization associated with the computing environment is communicated, the security posture visualization comprises a risk score identifier of an unsecured credential associated with accessing a resource in the computing environment. At block 406, the security posture visualization is caused to be displayed.

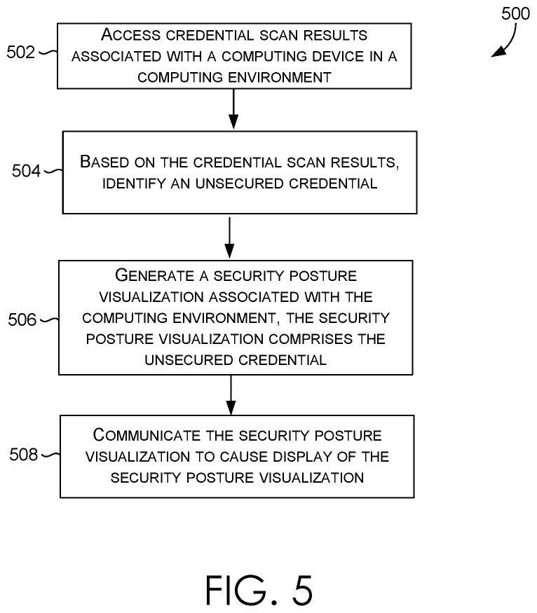

Turning to FIG. 5, a flow diagram is provided that illustrates a method 500 for providing security posture management using a credential-based security posture engine in a security management system. At block 502, credential scan results associated with a computing device in a computing environment are accessed. At block 504, an unsecured credential is identified. At block 506, a security posture visualization associated with the computing environment is generated, the security posture visualization comprises the unsecured credential. At block 508, the security posture visualization is communicated to cause display of the security posture visualization.

### Technical Improvement

Embodiments of the present technical solution have been described with reference to several inventive features (e.g., operations, systems, engines, and components) associated with a security management system. Inventive features described include: operations, interfaces, data structures, and arrangements of computing resources associated with providing the functionality described herein relative with reference to a credential-based security posture engine. Functionality of the embodiments of the present technical solution have further been described, by way of an implementation and anecdotal examples—to demonstrate that the operations for providing the credential-based security posture engine as a solution to a specific problem in security management technology to improve computing operations in security management systems. Overall, these improvements result in less CPU computation, smaller memory requirements, and increased flexibility in security management systems when compared to previous conventional security management system operations performed for similar functionality.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 6 in particular, an example operating environment for implementing embodiments of the present technical solution is shown and designated generally as computing device 600. Computing device 600 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing credentials scan results associated with a computing device in a computing environment;
based on the credentials scan results, identifying an unsecured credential associated with accessing a resource in the computing environment;
generating a risk score that quantifies a security exposure associated with the unsecured credential and the resource;
based on the risk score, generating a security posture visualization associated with computing environment, wherein the security posture visualization comprises the unsecured credential and the resource associated with the risk score; and
communicating the security posture visualization to cause display of the security posture visualization.

2. The system of claim 1, wherein a credential scanner, associated with a credential-based security posture engine, supports identifying, for a plurality of computing devices in the computing environment, a plurality of unsecured credentials and their corresponding resources, wherein the credential scan results comprise the unsecured credential and the resource.

3. The system of claim 1, the operations further comprising validating that the unsecured credential provides access to the resource in the computing environment.

4. The system of claim 1, the operations further comprising executing an attack path analysis based on the computing device, the unsecured credential, and the resource, wherein the executing the attack path analysis identifies an attack path associated with the computing device, the unsecured credential, and the resource.

5. The system of claim 1, wherein generating the risk score quantifies the security exposure based multiplying a probability score and an impact score associated with a security threat of the computing device, the unsecured credential, and the resource.

6. The system of claim 1, wherein a security posture management engine supports executing a risk assessment on a plurality of unsecured credentials, wherein executing the risk assessment comprises generating risk scores for each of the plurality of unsecured credentials to quantify their security exposure of the computing environment,
wherein each risk score is based on each corresponding unsecured credential and risk assessment factors of the unsecured credential,
wherein the risk assessment factors comprise the following: an unsecured credential type, a resource type, an unsecured credential validation status, and an attack path analysis.

7. The system of claim 1, wherein a security posture management engine supports generating a security posture visualization comprising a plurality of alerts, wherein an alert from the plurality alerts is associated with the unsecured credential and a prioritization identifier, wherein the plurality of alerts are provided in the security posture visualization based on their corresponding prioritization identifiers.

8. The system of claim 1, wherein security posture visualization comprises an alert associated with the unsecured credential, wherein the alert comprises a prioritization identifier and a remediation action, wherein the remediation action is executable to address a security threat associated with the alert.

9. The system of claim 1, the operations further comprising:
communicating, from a security management client, a request for a security posture of the computing environment;
based on the request, receiving the security posture visualization associated with the computing environment, wherein the security posture visualization comprises an alert associated with the computing device, the unsecured credential, and the resource; and
causing display of the security posture visualization.

10. The system of claim 1, the operations further comprising:
receiving an indication to execute a remediation action associated with the unsecured credential, wherein the remediation action is associated with the security posture visualization; and
communicating the indication to execute the remediation action to cause execution of the remediation action.

11. One or more computer-storage media having computer-executable instructions embodied thereon that, when executed by a computing system having a processor and memory, cause the processor to perform operations, the operations comprising:
communicating a request for a security posture of a computing environment;
based on the request, receiving a security posture visualization associated with the computing environment, wherein the security posture visualization comprises a risk score of an unsecured credential associated with accessing a resource in the computing environment; and
causing display of the security posture visualization.

12. The media of claim 11, wherein the risk score is based on the unsecured credential and corresponding risk assessment factors of the unsecured credential, wherein the risk assessment factors comprising the following: an unsecured credential type, a resource type, an unsecured credential validation status, and an attack path analysis.

13. The media of claim 11, wherein the security posture visualization comprises an alert associated with the unsecured credential, wherein the alert is associated with a prioritization identifier and a remediation action, wherein the remediation action is executable to address a security threat associated with the alert.

14. The media of claim 11, wherein the security posture visualization comprises a first plurality of alerts that are not associated with unsecured credentials and a second plurality of alerts that are associated with unsecured credentials, wherein the first plurality of alerts and the second plurality of alerts are provided in the security posture visualization based on corresponding prioritization identifiers.

15. The media of claim 11, the operations further comprising:
receiving an indication to perform a remediation action associated with the unsecured credential, wherein the remediation action is associated with the security posture visualization; and
communicating the indication to perform the remediation action to cause execution of the remediation action.

16. A computer-implemented method, the method comprising:
accessing credential scan results associated with a computing device in a computing environment;
based on the credential scan results, identifying an unsecured credential;
generating a security posture visualization associated with the computing environment, wherein the security posture visualization comprises the unsecured credential; and
communicating the security posture visualization to cause display of the security posture visualization.

17. The method of claim 16, the method further comprising executing an attack path analysis based on the computing device, the unsecured credential, and a resource accessible using the unsecured credential, wherein the executing the attack path analysis identifies an attack path associated with the computing device, the unsecured credential.

18. The method of claim 16, the method further comprising executing a risk assessment on the unsecured credential, wherein executing the risk assessment comprises generating the risk score based on risk assessment factors comprising the following: an unsecured credential type, a resource type, an unsecured credential validation status, and an attack path analysis.

19. The method of claim 16, wherein security posture visualization comprises an alert associated with the unsecured credential, wherein the alert comprises a prioritization identifier.

20. The method of claim 16, the method further comprising:
receiving an indication to perform a remediation action associated with the unsecured credential, wherein the remediation action is associated with the security posture visualization; and
based on receiving the indication to perform the remediation action, causing execution of the remediation action.
